(19) United States
(12) Patent Application Publication
(10) Pub. No.: US 2026/0158942 A1
(43) Pub. Date: Jun. 11, 2026

(54) DETACHABLE BI-DIRECTIONAL DOCKING STATION FOR ELECTRIC VEHICLES

(71) Applicant: TOYOTA MOTOR ENGINEERING & MANUFACTURING NORTH AMERICA, INC., Plano, TX (US)

(72) Inventor: Mackensie Monegan, Ann Arbor, MI (US)

(73) Assignees: TOYOTA MOTOR ENGINEERING & MANUFACTURING NORTH AMERICA, INC., Plano, TX (US); TOYOTA JIDOSHA KABUSHIKI KAISHA, Toyota-shi (JP)

(21) Appl. No.: 18/977,314

(22) Filed: Dec. 11, 2024

(51) Int. Cl. B60L 53/16; B60L 53/18; B60L 53/53; H02J 7/00; H02J 7/34

(52) U.S. Cl. CPC B60L 53/16; B60L 53/53; H02J 7/342; H02J 7/345; H02J 7/60; H02J 7/865; B60L 53/18

(57) ABSTRACT

Systems and methods for bi-directional charging and discharging of EV batteries using a bi-directional docking station having a detachable docking module. The docking stations include a detachably mounted docking module electrically connected to an interface port on the EV. In some embodiments, the EV has multiple hardwired interface ports in various locations to which the detachable docket station can be connected.

### TECHNICAL FIELD

The subject matter described herein relates generally to charging and discharging of electric vehicle (“EV”) batteries and, more particularly, to detachable docking stations for charging and discharging of EV batteries.

### BACKGROUND

EV owners are often confronted with having to recharge the EV away from home where charging cables and other electric vehicle supply equipment (“EVSE”) may not be available for that particular EV. Although there are a variety of components to assist with charging away from home, there is no universal docking station or interface where such components can be easily connected to for various purposes.

### SUMMARY

In view of the foregoing, the various embodiments described herein provide centralized docking stations for quick connects of portable equipment to connect to various ports at the central location (e.g., trunk area) instead of having to plug into various ports throughout the vehicle. Further, the disclosed embodiments access to the vehicle BUS, On-board ECU, and other EV systems. Any portable EVSE is contemplated, such as a portable EVSE, EV battery booster, or charging components for use with an EVSE charging station. Therefore, an EV owner is able to quickly transport charging equipment that is normally used at home and place it in the docking station to quickly connect to, for example, the EV's battery, on-board diagnostic unit, on-board Powertrain Control Unit (PCU) or on-board ECU, especially when traveling, on vacation, or at work where spare EVSE components are expensive or unavailable, or simply as emergency use equipment where quick release and docking is desirable in the event of an emergency (e.g., dead battery, jumping another vehicle, etc.).

A generalized embodiment provides a bi-directional docking station for an electric vehicle (“EV”), comprising an interface port on the EV and a detachable docking module configured to electrically connect to the interface port. The detachable docking module includes a spool having a charging cable and a bi-directional charging circuit configured to enable charging of the EV battery and discharging of the EV battery to supply power to external devices. The interface port of the EV is configured to connect to the detachable docking module and comprises at least one of an electrical outlet, at least one USB port; and an ON/OFF button.

This Summary is provided to introduce a selection of concepts in a simplified form that are further described below in the Detailed Description. This Summary is not intended to identify key features or essential features of the claimed subject matter, nor is it intended to limit the scope of the claimed subject matter. A more extensive presentation of features, details, utilities, and advantages of the system, as defined in the claims, is provided in the following written description of various embodiments of the disclosure and illustrated in the accompanying drawings.

### BRIEF DESCRIPTION OF THE DRAWINGS

Illustrative embodiments of the present disclosure will be described with reference to the accompanying drawings, of which:

FIG. 1 is a diagrammatic illustration of an EV system including a charging module in accordance with at least one embodiment of the present disclosure.

FIG. 2 is a diagrammatic illustration of the rear of an EV system for bi-directional charging and discharging, according to certain embodiments of the present disclosure.

FIG. 3A is a front view and top-down view along Section A-A of a detachable docking module according to certain illustrative embodiments of the present disclosure.

FIG. 3B is a front view and top-down view along Section A-A of a detachable docking module with a rechargeable energy storage device according to an alternative embodiment of the present disclosure.

FIG. 4 is a schematic diagram of a processor circuit, in accordance with at least one embodiment of the present disclosure.

### DETAILED DESCRIPTION

The present disclosure is generally directed to systems and methods for bi-directional charging and discharging of EV batteries using a bi-directional docking station having a detachable docking module. More specifically, the disclosed embodiments are directed to bidirectional docking stations for EV charging and discharging (e.g., Level-1 (120-V)). The docking stations include a detachably mounted docking module electrically connected to an interface port on the EV. In some embodiments, the EV has multiple hardwired interface ports in various locations (e.g., near the trunk, near the front bumper) to which the detachable docket station can be connected.

The detachably mounted docking module may include a spool or reel with an extendable and retractable charging cable. When electrically connected with the EV via the interface port, the detachable docking module is connected with both the battery and the ECU of the EV. In some embodiments, the detachable docking module includes its own energy storage device (e.g., a rechargeable battery, capacitor, hybrid capacitor) that enables the docking module, when detached from the vehicle and moved to, e.g., a campsite or other location, to act as a portable power source.

In certain embodiments, the hardwired interface port(s) include a female outlet (e.g., 120-V), one or more USB-C ports, and a power on/off (e.g., GFI) button. A user can, with an extension cord, use the female outlet on the hardwired interface port for bidirectional charging/discharging without the docking module being present, if desired. When not in use, the hardwired interface ports can be hidden by a flip-up or flip-down doors similar to that covering the charge inlet of the EV, when not in use.

The systems described herein may be implemented as a process at least partially implemented on a display, and operated by a control process executing on a processor that accepts user inputs from a suitable user-interface and other control devices, and that is in communication with one or more modules and remote processors. In that regard, the control process performs certain specific operations in response to different inputs or selections made at different times, and/or in response to real-time or near-real-time user inputs.

For the purposes of promoting an understanding of the principles of the present disclosure, reference will now be made to the embodiments illustrated in the drawings, and specific language will be used to describe the same. It is nevertheless understood that no limitation to the scope of the disclosure is intended. Any alterations and further modifications to the described devices, systems, and methods, and any further application of the principles of the present disclosure are fully contemplated and included within the present disclosure as would normally occur to one skilled in the art to which the disclosure relates. It is fully contemplated that the features, components, and/or steps described with respect to one embodiment may be combined with the features, components, and/or steps described with respect to other embodiments of the present disclosure. For the sake of brevity, however, the numerous iterations of these combinations will not be described separately.

These descriptions are provided for exemplary purposes, and should not be considered to limit the scope of the vehicle door activation system described herein. Certain features may be added, removed, or modified without departing from the spirit of the claimed subject matter.

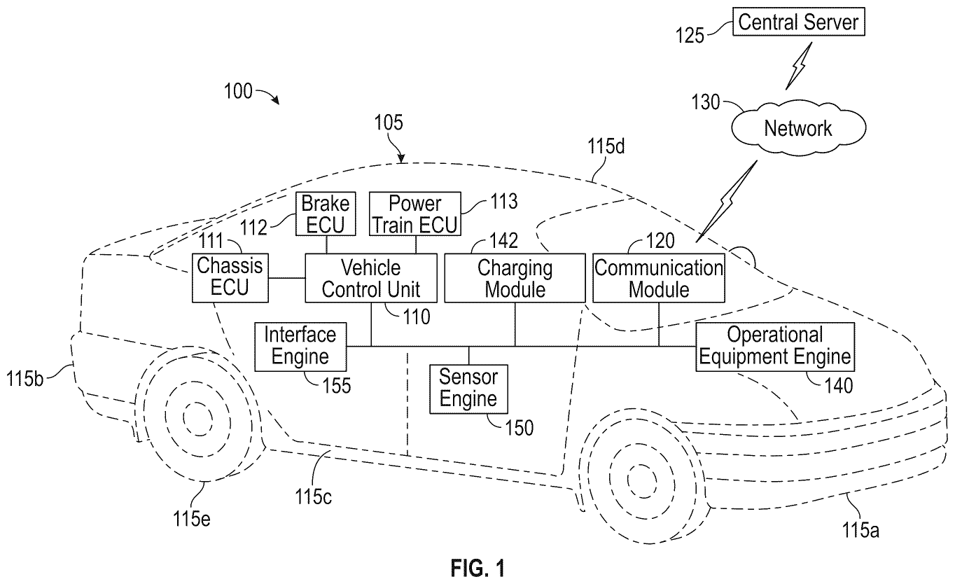

FIG. 1 is a diagrammatic illustration of an EV system including a charging module in accordance with at least one embodiment of the present disclosure. In this example, the EV system is referred to by the reference numeral 100 and includes a vehicle 105, such as a car, and a vehicle control unit 110 located on the vehicle 105. The vehicle 105 may include a front portion 115a (including a front bumper), a rear portion 115b (including a rear bumper), a right side portion 115c (including a right front quarter panel, a right front door, a right rear door, and a right rear quarter panel), a left side portion 115d (including a left front quarter panel, a left front door, a left rear door, and a left rear quarter panel), and wheels 115c. More specifically, the rear portion 115b includes a truck bed 117 having a tailgate member 118, a first side wall 119a and a second side wall 119b.

A communication module 120 is operably coupled to, and adapted to be in communication with, the vehicle control unit 110. The communication module 120 is adapted to communicate wirelessly with a central server 125 via a network 130 (e.g., a 3G network, a 4G network, a 5G network, a Wi-Fi network, or the like). The central server 125 may provide information and services including but not limited to include location, mapping, route or path, and topography information. Further, communication module 120 may communicate with a battery charging station using near-field communication or some other communication technique. However, that same charging station may also communicate with EV system 100 over network 130 in certain other embodiments.

An operational equipment engine 140 is operably coupled to, and adapted to be in communication with, the vehicle control unit 110 and charging module 142 which is utilized to perform the techniques described herein. A sensor engine 150 is operably coupled to, and adapted to be in communication with, the vehicle control unit 110. The charging module 142 is adapted to monitor the state of charge (SOC) of vehicle 105 assist with the charging and discharging process, as described herein.

An interface engine 155 is operably coupled to, and adapted to be in communication with, the vehicle control unit 110. In addition to, or instead of, being operably coupled to, and adapted to be in communication with, the vehicle control unit 110, the communication module 120, the operational equipment engine 140, the sensor engine 150, and/or the interface engine 155 may be operably coupled to, and adapted to be in communication with, another of the components via wired or wireless communication (e.g., via an in-vehicle network). In some examples, the vehicle control unit 110 is adapted to communicate with the communication module 120, the operational equipment engine 140, the sensor engine 150, and the interface engine 155 to at least partially control the interaction of data with and between the various components of EV system 100.

The term “engine” is meant herein to refer to an agent, instrument, or combination of either, or both, agents and instruments that may be associated to serve a purpose or accomplish a task-agents and instruments may include sensors, actuators, switches, relays, power plants, system wiring, computers, components of computers, programmable logic devices, microprocessors, software, software routines, software modules, communication equipment, networks, network services, and/or other elements and their equivalents that contribute to the purpose or task to be accomplished by the engine. Accordingly, some of the engines may be software modules or routines, while others of the engines may be hardware and/or equipment elements in communication with any or all of the vehicle control unit 110, the communication module 120, the network 130, or a central server 125.

In this example, the vehicle 105 also includes a chassis electronic control unit (ECU) 111 which controls elements of the vehicle's suspension system, a brake ECU 112 which controls the braking system or elements thereof, a power train ECU 113 (variously known as an engine ECU, power plant ECU, motor ECU, transmission ECU or PCU) that controls elements of the motor and drivetrain, and sensor engine 150.

A reader of ordinary skill in the art will understand that other components or arrangements of components may be found in a vehicle 105, and that the same general principles apply to electric vehicles, internal combustion vehicles, and hybrid vehicles. For example, a power train ECU 113 may control both motor and transmission components. Alternatively, a separate motor ECU and transmission ECU may exist, or some functions of a motor ECU or transmission ECU may be performed by the VCU 110.

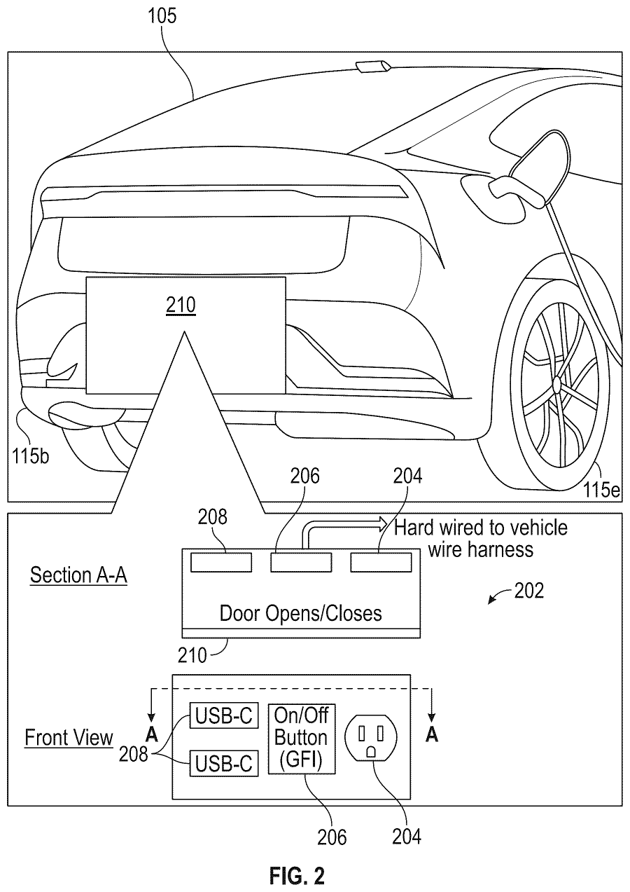

FIG. 2 is a diagrammatic illustration of an EV system for bi-directional charging and discharging, according to certain embodiments of the present disclosure. Vehicle 105 is shown from the rear, with rear bumper portion 115b emphasized. In this example, an interface port 202 is shown as a top-down view along Section A-A and a front view. Note, in alternative embodiments, interface port 202 may be located on the front bumper or otherwise on vehicle 105. Interface port 202 is hard wired to the wiring harness of vehicle 105 in order to bi-directionally communicate both power and data. Further, the hard wiring enables the VCU 110 and charging module 142 to manage and control charging related functions.

Referring to the front view of interface port 202, an outlet 204 (e.g., female 120V outlet) is provided to which various appliances or other electrical devices may be plugged. Alternatively, other voltage rated outlets may be provided (e.g., male outlet, 240 volts, etc.), as well as Level 2 (240 V) and 3 (DC) charging capabilities. An ON/OFF button or switch 206 is also provided on interface port 202 to power on and off interface port 202. One or more USB outlets 208 are also provided for power and/or data transfers to/from vehicle 105. Because interface port 202 is hardwired directly to the on-board energy storage components and the battery of vehicle 105, interface port 202 may receive auxiliary batteries or battery boosters to provide a dead vehicle battery with enough power to drive to a suitable location.

A cover 210 is positioned on top of the interface port 202 in order to protect it from the environment. Cover 210 is adapted to be open in a variety of ways such as, for example, a hinge or other opening mechanisms. When not in use, cover 210 may be closed. When in use, cover 210 is removed or opened.

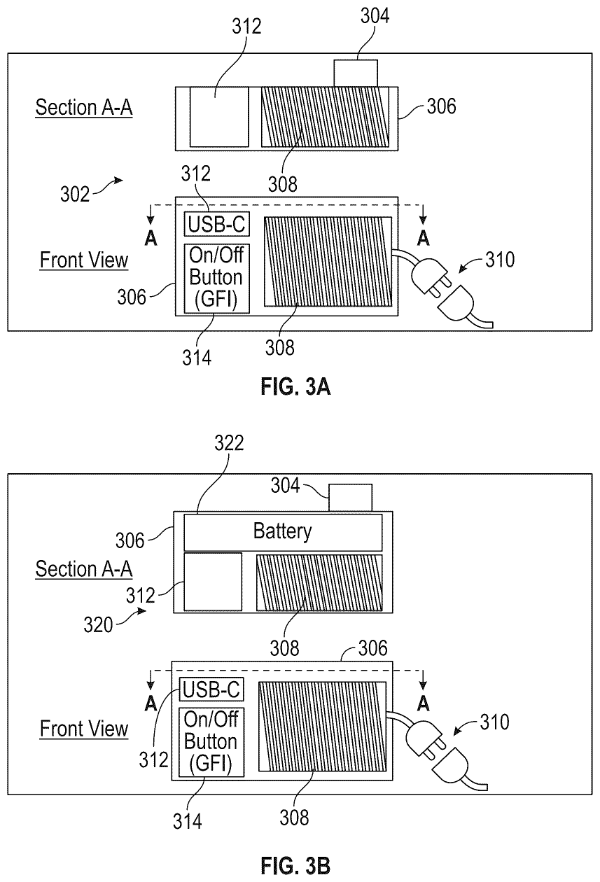

FIG. 3A is a front view and top-down view along Section A-A of a detachable docking module according to certain illustrative embodiments of the present disclosure. Detachable docking module 302 includes a bi-directional charging circuit configured to enable charging of the battery onboard vehicle 105 and discharging of the battery of vehicle 105 to supply power to external devices. Further, docking module 302 is configured to electrically connect to interface port 202 via an outlet 304 that mates with outlet 204 (e.g., 120V, 240V) positioned on the back of housing 306. In the example when outlet 204 is a female outlet, outlet 304 would be a male outlet with the corresponding voltage rating. In certain examples, outlet 304 may be a foldable outlet adapted to fold down flush with housing 306 when not in use. Docking module 302 includes a charging cable spool 308 which can extend and retract from/into housing 306. Spool 308 also includes a male or female outlet 310 (e.g., 120V, 240V) at the distal end to allow bi-directional charging (e.g., vehicle-to-vehicle charging, powering of external appliances, etc). Further, in this example, detachable docking module 302 includes one or more USB outlets 312, in addition to an ON/OFF button 314.

FIG. 3B is a front view and top-down view along Section A-A of a detachable docking module according to an alternative embodiment of the present disclosure. Detachable docking module 320 is similar to detachable docking module 302 of FIG. 3A, as like numerals refer to like numerals. Docking module 320 includes a bi-directional charging circuit configured to enable charging of the battery onboard vehicle 105 and discharging of the battery of vehicle 105 to supply power to external devices. Further, docking module 320 is configured to electrically connect to interface port 202 via an outlet 304 that mates with outlet 204 (e.g., 120V, 240V) positioned on the back of housing 306. In the example when outlet 204 is a female outlet, outlet 304 would be a male outlet with the corresponding voltage rating. In certain examples, outlet 304 may be a foldable outlet adapted to fold down flush with housing 306 when not in use. Docking module 320 includes a charging cable spool 308 which can extend and retract from/into housing 306. Spool 308 also includes a male or female outlet 310 (e.g., 120V, 240V) at the distal end to allow bi-directional charging (e.g., vehicle-to-vehicle charging, powering of external appliances, etc.). Further, in this example, detachable docking module 320 includes one or more USB outlets 312, in addition to an ON/OFF button 314.

However, detachable docking module 320 also includes an energy storage device 322 (e.g., rechargeable battery, capacitor, hybrid capacitor) which stores electrical energy for portable use when docking module 320 is not attached to interface port 202. In one example, when outlet 304 is attached to outlet 204 of interface port 202, energy storage device 322 may be charged. Thereafter, docking module 320 may be disconnected from outlet 204 and moved to charge/provide power to a separate device such as, for example, another car battery or electrical appliance.

Accordingly, the illustrative embodiments of the present disclosure discussed herein provide docking or nesting cradles to hold portable EVSE such as EV booster cables, bidirectional charging cables, plug-in charging plugs, etc. Users are able to quickly connect portable charging equipment that have the docking interface compatible with the interface port. Because the interface port is hardwired directly to the on-board energy storage components and EV battery, the interface port and/or docking module may receive auxiliary batteries or battery boosters to provide a dead battery with enough power to safely drive home or to the nearest charging station. Further, the interface port and detachable docking station may be used with compatible charging components, plugs, cables, battery booster, ODU/maintenance, or to access the vehicle's ECU. Much like an ODU port is used for diagnosing and obtaining vehicle data, the interface port and docking station provide a similar interface while housing/securing/charging the portable equipment, if necessary.

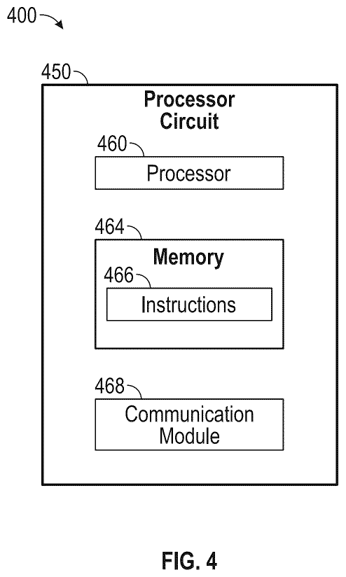

FIG. 4 is a schematic diagram of a processor circuit 450, in accordance with at least one embodiment of the present disclosure. The processor circuit 450 may be implemented in the EV system 100 (e.g., as part of charging module 142) or other devices or workstations (e.g., third-party workstations, network routers, etc.), or on a cloud processor or other remote processing unit, as necessary to implement the methods described herein. As shown, the processor circuit 450 may include a processor 460, a memory 464 having instructions 466 thereon, and a communication module 468. These elements may be in direct or indirect communication with each other, for example via one or more buses.

The processor 460 may include a central processing unit (CPU), a digital signal processor (DSP), an ASIC, a controller, or any combination of general-purpose computing devices, reduced instruction set computing (RISC) devices, application-specific integrated circuits (ASICs), field programmable gate arrays (FPGAs), or other related logic devices, including mechanical and quantum computers. The processor 460 may also comprise another hardware device, a firmware device, or any combination thereof configured to perform the operations described herein. The processor 460 may also be implemented as a combination of computing devices, e.g., a combination of a DSP and a microprocessor, a plurality of microprocessors, one or more microprocessors in conjunction with a DSP core, or any other such configuration.

The memory 464 may include a cache memory (e.g., a cache memory of the processor 660), random access memory (RAM), magnetoresistive RAM (MRAM), read-only memory (ROM), programmable read-only memory (PROM), erasable programmable read only memory (EPROM), electrically erasable programmable read only memory (EEPROM), flash memory, solid state memory device, hard disk drives, other forms of volatile and non-volatile memory, or a combination of different types of memory. In an embodiment, the memory 464 includes a non-transitory computer-readable medium. The memory 464 may store instructions 466. The instructions 466 may include instructions that, when executed by the processor 460, cause the processor 460 to perform the operations described herein. Instructions 466 may also be referred to as code. The terms “instructions” and “code” should be interpreted broadly to include any type of computer-readable statement(s). For example, the terms “instructions” and “code” may refer to one or more programs, routines, sub-routines, functions, procedures, etc. “Instructions” and “code” may include a single computer-readable statement or many computer-readable statements.

The communication module 468 can include any electronic circuitry and/or logic circuitry to facilitate direct or indirect communication of data between the processor circuit 450, and other processors or devices. In that regard, the communication module 468 can be an input/output (I/O) device. In some instances, the communication module 468 facilitates direct or indirect communication between various elements of the processor circuit 450 and/or the system 100. The communication module 468 may communicate within the processor circuit 450 through numerous methods or protocols. Serial communication protocols may include but are not limited to United States Serial Protocol Interface (US SPI), Inter-Integrated Circuit (I²C), Recommended Standard 232 (RS-232), RS-485, Controller Area Network (CAN), Ethernet, Aeronautical Radio, Incorporated 429 (ARINC 429), MODBUS, Military Standard 1553 (MIL-STD-1553), or any other suitable method or protocol. Parallel protocols include but are not limited to Industry Standard Architecture (ISA), Advanced Technology Attachment (ATA), Small Computer System Interface (SCSI), Peripheral Component Interconnect (PCI), Institute of Electrical and Electronics Engineers 488 (IEEE-488), IEEE-1284, and other suitable protocols. Where appropriate, serial and parallel communications may be bridged by a Universal Asynchronous Receiver Transmitter (UART), Universal Synchronous Receiver Transmitter (USART), or other appropriate subsystem.

External communication (including but not limited to software updates, firmware updates, preset sharing between the processor and central server, or readings from vehicle or environmental sensors) may be accomplished using any suitable wireless or wired communication technology, such as a cable interface such as a universal serial bus (USB), micro USB, Lightning, or Fire Wire interface, Bluetooth, Wi-Fi, ZigBee, Li-Fi, or cellular data connections such as 2G/GSM (global system for mobiles), 3G/UMTS (universal mobile telecommunications system), 4G, long term evolution (LTE), WiMax, or 5G. For example, a Bluetooth Low Energy (BLE) radio can be used to establish connectivity with a cloud service, for transmission of data, and for receipt of software patches. The controller may be configured to communicate with a remote server, or a local device such as a laptop, tablet, or handheld device, or may include a display capable of showing status variables and other information. Information may also be transferred on physical media such as a USB flash drive or memory stick.

The technology described herein may be implemented on manually controlled vehicles or driver-assist vehicles. The technology may be implemented in diverse combinations of hardware, software, and firmware, depending on the implementation or as necessitated by the structures and modules already present in existing vehicles. The system may be employed on vehicles with automatic transmission, manual transmissions, or vehicles with simulated shifting, including continuously variable transmission (CVT), infinitely variable transmission (IVT), hybrid transmissions (e.g., a hybrid vehicle with 4-speed automatic transmission simulating 10 gears), and fully electric vehicles.

Accordingly, the logical operations making up the embodiments of the technology described herein may be referred to variously as operations, steps, blocks, objects, elements, components, or modules. Furthermore, it should be understood that these may occur or be arranged in any order, unless explicitly claimed otherwise or a specific order is necessitated by the claim language or by the nature of the component or step.

These and other advantages will be readily apparent to those ordinarily skilled in the art having the benefit of this disclosure.

Methods and embodiments described herein further relate to any one or more of the following paragraphs:

1. A bi-directional docking station for an electric vehicle (“EV”), comprising: an interface port on the EV; and a detachable docking module configured to electrically connect to the interface port, the detachable docking module comprising: a spool having a charging cable; and a bi-directional charging circuit configured to enable charging of a battery of the EV (“EV battery”) and discharging of the EV battery to supply power to external devices, wherein the interface port of the EV is configured to connect to the detachable docking module and comprises at least one of: an electrical outlet; a USB port; and an on/off button.
2. The bi-directional docking station as defined in paragraph 1, wherein the detachable docking module further comprises an energy storage device configured to store electrical energy for portable use when the detachable docking module is detached from the EV.
3. The bi-directional docking station as defined in paragraphs 1 or 2, wherein the detachable docking module is communicably coupled to an electronic control unit (“ECU”) of the EV, via the interface port, to manage charging and discharging operations.
4. The bi-directional docking station as defined in any of paragraphs 1-3, wherein the energy storage device is at least one of a rechargeable battery, capacitor or hybrid capacitor, thereby enabling the detachable docking module to act as a portable power source for external devices when the detachable docking module is detached from the EV.
5. The bi-directional docking station as defined in any of paragraphs 1-4, wherein the hardwired interface port is positioned at a location near a front bumper or trunk of the EV.
6. The bi-directional docking station as defined in any of paragraphs 1-5, wherein the electrical outlet is a 120-V outlet allowing connection of an external cord for bi-directional charging or discharging operations without requiring the detachable docking module.
7. An electric vehicle (“EV”) system for bi-directional charging and discharging, comprising: an interface port on an EV; and a detachable docking module configured to electrically connect to the interface port, the detachable docking module comprising: a spool having a charging cable; and a bi-directional charging circuit configured to enable charging of a battery of the EV (“EV battery”) and discharging of the EV battery to supply power to external devices, wherein the interface port of the EV is configured to connect to the detachable docking module and comprises at least one of: an electrical outlet; a USB port; and an on/off button.
8. The EV system as defined in paragraph 7, wherein the detachable docking module further comprises an energy storage device configured to store electrical energy for portable use when the detachable docking module is detached from the EV.
9. The EV system as defined in paragraphs 7 or 8, wherein the detachable docking module is communicably coupled to an electronic control unit (“ECU”) of the EV, via the interface port, to manage charging and discharging operations.
10. The EV system as defined in any of paragraphs 7-9, wherein the energy storage device is a rechargeable battery, capacitor or hybrid capacitor, thereby enabling the detachable docking module to act as a portable power source for external devices when the detachable docking module is detached from the EV.
11. The EV system as defined in any of paragraphs 7-10, wherein the hardwired interface port is positioned at a location near a front bumper or trunk of the EV.
12. The EV system as defined in any of paragraphs 7-11, wherein the electrical outlet is a 120-V outlet allowing connection of an external cord for bi-directional charging or discharging operations without requiring the detachable docking module.
13. A method to provide bi-directional charging and discharging for an electric vehicle (“EV”), the method comprising: providing an interface port on the EV; and providing a detachable docking module configured to electrically connect to the interface port, the detachable docking module comprising: a spool having a charging cable; and a bi-directional charging circuit configured to enable charging of a battery of the EV (“EV battery”) and discharging of the EV battery to supply power to external devices, wherein the interface port of the EV is configured to connect to the detachable docking module and comprises at least one of: an electrical outlet; a USB port; and an on/off button.
14. The method as defined in paragraph 13, wherein the detachable docking module further comprises an energy storage device configured to store electrical energy for portable use when the detachable docking module is detached from the EV.
15. The method as defined in paragraphs 13 or 14, wherein the detachable docking module is communicably coupled to an electronic control unit (“ECU”) of the EV, via the interface port, to manage charging and discharging operations.
16. The method as defined in any of paragraphs 13-15, wherein the energy storage device is a rechargeable battery, capacitor or hybrid capacitor, thereby enabling the detachable docking module to act as a portable power source for external devices when the detachable docking module is detached from the EV.
17. The method as defined in any of paragraphs 13-16, wherein the hardwired interface port is positioned at a location near a front bumper of the EV.
18. The method as defined in any of paragraphs 13-17, wherein the hardwired interface port is position at a location near a trunk of the EV.
19. The method as defined in any of paragraphs 13-18, wherein the electrical outlet is a 120-V outlet allowing connection of an external cord for bi-directional charging or discharging operations without requiring the detachable docking module.
20. The method as defined in any of paragraphs 13-19, further comprising providing a flip door to conceal the hardwired interface port when the detachable docking module is not connected.

All directional references e.g., upper, lower, inner, outer, upward, downward, left, right, lateral, front, back, top, bottom, above, below, vertical, horizontal, clockwise, counterclockwise, proximal, and distal are only used for identification purposes to aid the reader's understanding of the claimed subject matter, and do not create limitations, particularly as to the position, orientation, or use of the cargo seat adjustment system. Connection references, e.g., attached, coupled, connected, and joined are to be construed broadly and may include intermediate members between a collection of elements and relative movement between elements unless otherwise indicated. As such, connection references do not necessarily imply that two elements are directly connected and in fixed relation to each other. The term “or” shall be interpreted to mean “and/or” rather than “exclusive or.” Unless otherwise noted in the claims, stated values shall be interpreted as illustrative only and shall not be taken to be limiting.

The above specification, examples and data provide a complete description of the structure and use of exemplary embodiments of the vehicle door activating system as defined in the claims. Although various embodiments of the claimed subject matter have been described above with a certain degree of particularity, or with reference to one or more individual embodiments, those skilled in the art could make numerous alterations to the disclosed embodiments without departing from the spirit or scope of the claimed subject matter. Additionally, sensors external to the vehicle may be employed to provide or supplement any of the sensor data described hereinabove. Alternatively, machine learning algorithms or other AI systems may be used to estimate variables from sparse, noisy, or entwined data streams without departing from the spirit of the present disclosure.

Still other embodiments are contemplated. It is intended that all matter contained in the above description and shown in the accompanying drawings shall be interpreted as illustrative only of particular embodiments and not limiting. Changes in detail or structure may be made without departing from the basic elements of the subject matter as defined in the following claims.

What is claimed is:

1. A bi-directional docking station for an electric vehicle (“EV”), comprising:
an interface port on the EV; and
a detachable docking module configured to electrically connect to the interface port, the detachable docking module comprising:
a spool having a charging cable; and
a bi-directional charging circuit configured to enable charging of a battery of the EV (“EV battery”) and discharging of the EV battery to supply power to external devices,
wherein the interface port of the EV is configured to connect to the detachable docking module and comprises at least one of:
an electrical outlet;
a USB port; and
an on/off button.

2. The bi-directional docking station as defined in claim 1, wherein the detachable docking module further comprises an energy storage device configured to store electrical energy for portable use when the detachable docking module is detached from the EV.

3. The bi-directional docking station as defined in claim 1, wherein the detachable docking module is communicably coupled to an electronic control unit (“ECU”) of the EV, via the interface port, to manage charging and discharging operations.

4. The bi-directional docking station as defined in claim 2, wherein the energy storage device is at least one of a rechargeable battery, capacitor or hybrid capacitor, thereby enabling the detachable docking module to act as a portable power source for external devices when the detachable docking module is detached from the EV.

5. The bi-directional docking station as defined in claim 1, wherein the hardwired interface port is positioned at a location near a front bumper or trunk of the EV.

6. The bi-directional docking station as defined in claim 1, wherein the electrical outlet is a 120-V outlet allowing connection of an external cord for bi-directional charging or discharging operations without requiring the detachable docking module.

7. An electric vehicle (“EV”) system for bi-directional charging and discharging, comprising:
an interface port on an EV; and
a detachable docking module configured to electrically connect to the interface port, the detachable docking module comprising:
a spool having a charging cable; and
a bi-directional charging circuit configured to enable charging of a battery of the EV (“EV battery”) and discharging of the EV battery to supply power to external devices,
wherein the interface port of the EV is configured to connect to the detachable docking module and comprises at least one of:
an electrical outlet;
a USB port; and
an on/off button.

8. The EV system as defined in claim 7, wherein the detachable docking module further comprises an energy storage device configured to store electrical energy for portable use when the detachable docking module is detached from the EV.

9. The EV system as defined in claim 7, wherein the detachable docking module is communicably coupled to an electronic control unit (“ECU”) of the EV, via the interface port, to manage charging and discharging operations.

10. The EV system as defined in claim 8, wherein the energy storage device is a rechargeable battery, capacitor or hybrid capacitor, thereby enabling the detachable docking module to act as a portable power source for external devices when the detachable docking module is detached from the EV.

11. The EV system as defined in claim 7, wherein the hardwired interface port is positioned at a location near a front bumper or trunk of the EV.

12. The EV system as defined in claim 7, wherein the electrical outlet is a 120-V outlet allowing connection of an external cord for bi-directional charging or discharging operations without requiring the detachable docking module.

13. A method to provide bi-directional charging and discharging for an electric vehicle (“EV”), the method comprising:
providing an interface port on the EV; and
providing a detachable docking module configured to electrically connect to the interface port, the detachable docking module comprising:
a spool having a charging cable; and
a bi-directional charging circuit configured to enable charging of a battery of the EV (“EV battery”) and discharging of the EV battery to supply power to external devices,
wherein the interface port of the EV is configured to connect to the detachable docking module and comprises at least one of:
an electrical outlet;
a USB port; and
an on/off button.

14. The method as defined in claim 13, wherein the detachable docking module further comprises an energy storage device configured to store electrical energy for portable use when the detachable docking module is detached from the EV.

15. The method as defined in claim 13, wherein the detachable docking module is communicably coupled to an electronic control unit (“ECU”) of the EV, via the interface port, to manage charging and discharging operations.

16. The method as defined in claim 14, wherein the energy storage device is a rechargeable battery, capacitor or hybrid capacitor, thereby enabling the detachable docking module to act as a portable power source for external devices when the detachable docking module is detached from the EV.

17. The method as defined in claim 13, wherein the hardwired interface port is positioned at a location near a front bumper of the EV.

18. The method as defined in claim 13, wherein the hardwired interface port is position at a location near a trunk of the EV.

19. The method as defined in claim 13, wherein the electrical outlet is a 120-V outlet allowing connection of an external cord for bi-directional charging or discharging operations without requiring the detachable docking module.

20. The method as defined in claim 13, further comprising providing a flip door to conceal the hardwired interface port when the detachable docking module is not connected.
